(19) United States
(12) Patent Application Publication
(10) Pub. No.: US 2005/0054297 A1
(43) Pub. Date: Mar. 10, 2005

(54) Wireless communication system

(75) Inventor: Kazuya Inagaki, Kanagawa-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/935,023

(22) Filed: Sep. 7, 2004

(30) Foreign Application Priority Data
Sep. 9, 2003 (JP) 2003-316855

(51) Int. Cl. H04Q 7/20

(52) U.S. Cl. 455/63.4

(57) ABSTRACT

A wireless communication system has a plurality wireless access points. Each of the wireless access points is provided for a desk or a chair that fixes the position of a wireless communication terminal. Each wireless access point includes a directional antenna having a directivity that is directed to the position at which the corresponding terminal is fixed.

### BACKGROUND OF THE INVENTION

1. Field of the Invention

The present invention relates to a wireless communication system having a plurality of wireless access points, and more specifically relates to a wireless communication system suitable for use in wireless local area network (LAN) technologies, namely, “hot-spot” communication technologies capable of providing wireless Internet connection services to the general public.

2. Description of the Related Art

Japanese Unexamined Patent Application Publication No. 2003-179532 discloses a wireless communication system. In this wireless communication system, a plurality of wireless access points, each having a wireless antenna and a radio wave absorber surrounding the wireless antenna, are provided in a busy location, such as an exhibition hall or a conference hall, around the ceiling of such a hall, and radio waves emitted from the lower portion of the wireless antennas are absorbed by a radio wave absorber located on the floor.

Japanese Unexamined Patent Application Publication No. 10-323237 discloses a distributed antenna system. This system is disposed in the vicinity of the ceiling of a classroom or a lecture room so that a teacher and students can communicate through wireless communication between terminals mounted on modular office components on the floor.

FIG. 3 is a diagram of a wireless communication system of the related art suitable for use in Internet connection services, as disclosed in the above-noted publications. FIG. 4 is a diagram of another wireless communication system of the related art.

The basic structure of a wireless communication system of the related art suitable for use in Internet connection services will be described with reference to FIGS. 3 and 4.

The wireless communication system shown in FIG. 3 is disposed between a ceiling 21 and a floor 20. A plurality of wireless access points ap1 to ap3 are formed in the vicinity of the ceiling 21. The wireless access points ap1 to ap3 include wireless antennas 27A to 27C, and radio wave absorbers 28A to 28C surrounding the wireless antennas 27A to 27C, respectively.

Desks 22 to 24 are fixed to the floor 20, and wireless communication terminals 25A to 25C having wireless antennas 26A to 26C are located on the desks 22 to 24. Radio waves 30A to 30C emitted towards the floor 20 from the wireless antennas 27A to 27C of the wireless access points ap1 to ap3 are absorbed by a radio wave absorber 29 formed over the floor 20.

The wireless communication system shown in FIG. 4 has substantially the same basic structure as that shown in FIG. 3. In the wireless communication system shown in FIG. 3, the wireless antennas 26A to 26C of the terminals 25A to 25C are located immediately below the wireless access points ap1 to ap3 so as to be aligned in a one-to-one relation. In the wireless communication system shown in FIG. 4, on the other hand, the distance between the floor 20 and the ceiling 21 is larger, and the wireless antennas 26A to 26C of the terminals 25A to 25C are not aligned with the wireless access points ap1 to ap3, respectively.

The wireless communication systems of the related art shown in FIGS. 3 and 4 have problems.

In the wireless communication system shown in FIG. 3, it is necessary to set the distance between the wireless access points ap1 to ap3 and the terminals 25A to 25C to a predetermined value L. The value L is different depending upon the size of building in which the wireless communication system is located, namely, the height of the ceiling 21. Thus, a time-consuming operation for adjusting the distance between the wireless access points ap1 to ap3 and the terminals 25A to 25C is required each time the wireless communication system is installed in a particular place, and the cost thus increases.

In the wireless communication system shown in FIG. 4, the radio waves 30A to 30C emitted from the radio antennas 27A to 27C of the wireless access points ap1 to ap3 can interfere with each other due to the positional misalignment between the wireless access points ap1 to ap3 and the terminals 25A to 25C, leading to degradation in the performance of the wireless communication system. In FIG. 4, for example, the radio waves 30A and 30B emitted from the wireless antennas 27A and 27B can be received by the wireless antenna 26B of the terminal 25B, and interference occurs.

### SUMMARY OF THE INVENTION

Accordingly, it is an object of the present invention to provide a wireless communication system that does not require adjustment of the distance between wireless access points and terminals each time the wireless communication system is installed in a particular location and that allows one-to-one correspondence between wireless antennas of the wireless access points and the terminals.

The present invention provides a wireless communication system having a plurality of wireless access points. Each of the wireless access points is provided for a terminal fixing unit for fixing the position of a wireless communication terminal, and each wireless access point includes a directional antenna having a directivity that is directed to the position at which the terminal is fixed.

The wireless access points are provided for terminal fixing units to which the terminals are fixed, and the distance between the terminals and the wireless access points is set to a predetermined value regardless of the size of building in which the wireless communication system is located. No operation is required for adjusting the distance between the wireless access points and the terminals each time the wireless communication system is installed in a particular place. Therefore, the wireless communication system can easily be installed.

The directional antennas of the wireless access points are directed to the corresponding terminals. This ensures positional alignment between the directional antennas and the terminals, and no interference can occur.

Since the directional antennas are directed to the corresponding terminals, communication is realized with a low output of the radio waves emitted from the directional antennas. Each of the directional antennas receives only the signal output from the corresponding terminal, resulting in high signal-to-noise (S/N) ratio of the signal received by this directional antenna.

In the wireless communication system of the present invention, the terminal fixing unit may be a desk having a stage portion for carrying the terminal, and the directional antenna may be disposed in the desk so as to be directed to the stage portion of the desk.

Since the terminal is located on the stage portion of the desk, the position of the terminal can accurately be determined, and the directional antenna can therefore be directed to the terminal with accuracy.

In the wireless communication system of the present invention, the directional antenna may be disposed in a leg portion of the desk.

In this case, the directional antenna is directed to the stage portion of the desk, that is, to the ceiling, from the leg portion of the desk. The radio waves emitted from the directional antenna do not reach terminals other than the corresponding terminal, and no interference can occur.

In the wireless communication system of the present invention, a radio wave absorber may be provided so as to surround the desk, and the directional antenna may have a directivity capable of transmitting and receiving radio waves in an area that is covered by the radio wave absorber.

In this way, the positional relationship between the desk and the radio wave absorber can be fixed. For example, the radio wave absorber and the desk may be integrally formed. Therefore, the directional antenna provided for the desk and the radio wave absorber can accurately be positioned.

In the wireless communication system of the present invention, a second radio wave absorber may be provided at a predetermined position above the desk.

The radio waves emitted from each directional antenna are also absorbed by the second radio wave absorber disposed above the desk, which prevents the occurrence of interference.

In the wireless communication system of the present invention, the terminal fixing unit may be a chair on which an operator who operates the terminal sits, and the directional antenna may be disposed in the chair so as to be directed to a predetermined space above a seat of the chair.

Since the terminal is placed on the chair through the operator, the position of the terminal is substantially accurately determined, and the directional antenna can therefore be directed to the terminal with accuracy.

In the wireless communication system of the present invention, the directional antenna may be disposed in a leg portion of the chair.

In this case, the directional antenna is directed to the seat of the chair, that is, to the ceiling, from the leg portion of the chair. The radio waves emitted from the directional antenna do not reach terminals other than the corresponding terminal, and no interference can occur.

In the wireless communication system of the present invention, a radio wave absorber may be provided so as to surround the chair, and the directional antenna may have a directivity capable of transmitting and receiving radio waves in an area that is covered by the radio wave absorber.

In this way, the positional relationship between the chair and the radio wave absorber can be fixed. Therefore, the directional antenna provided for the chair and the radio wave absorber can accurately be positioned.

In the wireless communication system of the present invention, a second radio wave absorber may be provided at a predetermined position above the chair.

The radio waves emitted from the directional antenna are also absorbed by the second radio wave absorber disposed above the chair, which prevents the occurrence of interference.

According to a wireless communication system of the present invention, therefore, the distance between terminals and wireless access points need not be adjusted each time the wireless communication system is installed in a particular place. Thus, the wireless communication system can easily be installed at low cost over the related art. Moreover, positional alignment between directional wireless antennas of the wireless access points and terminals prevents the occurrence of interference. Therefore, high-accuracy wireless communication is realized.

### BRIEF DESCRIPTION OF THE DRAWINGS

FIG. 1 is a diagram of a wireless communication system according to a first embodiment of the present invention;

FIG. 2 is a diagram of a wireless communication system according to a second embodiment of the present invention;

FIG. 3 is a diagram of a wireless communication system of the related art; and

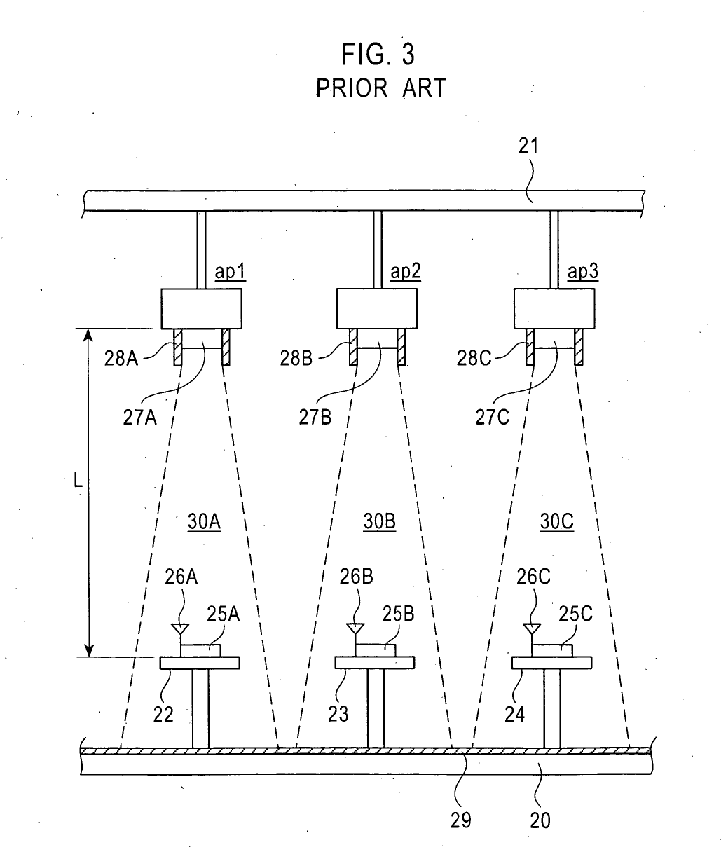

FIG. 4 is a diagram of another wireless communication system of the related art.

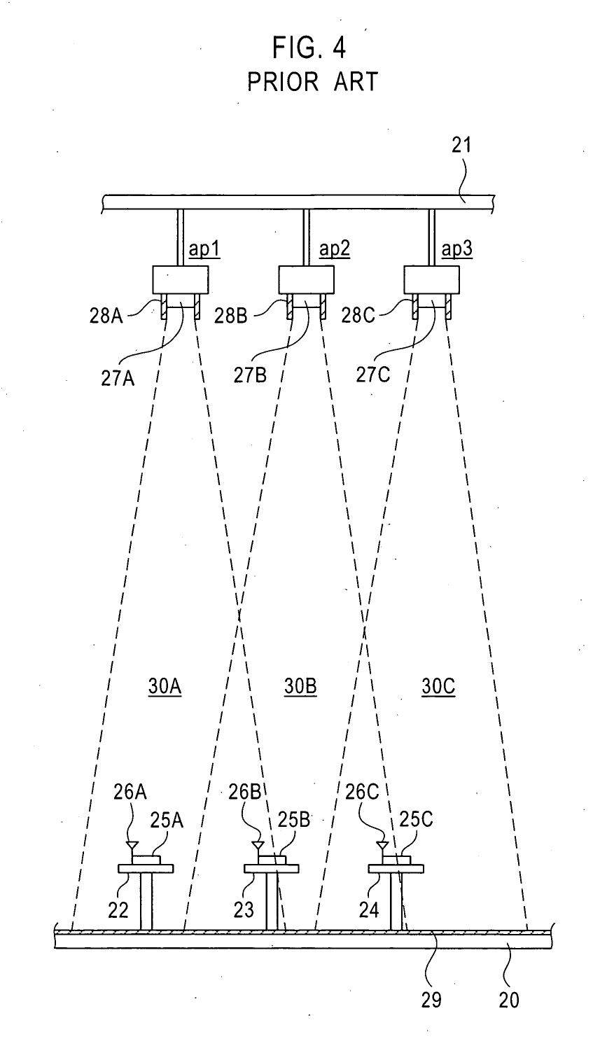

### DESCRIPTION OF THE PREFERRED EMBODIMENTS

A wireless communication system according to the present invention will now be described with reference to the drawings.

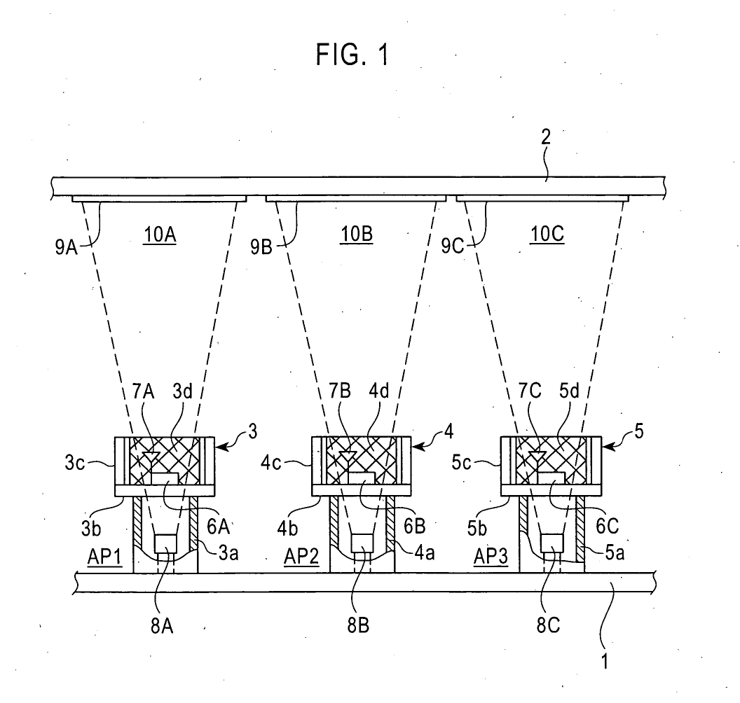

FIG. 1 is a diagram of a wireless communication system according to a first embodiment of the present invention. The wireless communication system shown in FIG. 1 is disposed between a floor 1 and a ceiling 2 of, for example, a public building. In this wireless communication system, wireless access points AP1 to AP3 are provided for terminal fixing units for fixing the position of wireless communication terminals 6A to 6C, e.g., desks 3 to 5 on the floor 1.

The desks 3 to 5 include leg portions 3a to 5a, stage portions 3b to 5b supported by the leg portions 3a to 5a, which serve as desk tops for carrying the terminals 6A to 6C, and wall portions 3c to 5c surrounding the stage portions 3b to 5b on, for example, three sides.

The wireless access points AP1 to AP3 include wireless directional antennas 8A to 8C. The directional antennas 8A to 8C are located in the desks 3 to 5, e.g., in the leg portions 3a to 5a of the desks 3 to 5, so that the directional antennas 8A to 8C are directed to the stage portions 3b to 5b on which the terminals 6A to 6C are located.

Radio wave absorbers 3d to 5d are formed on the surroundings of the desks 3 to 5, e.g., the inner surfaces of the wall portions 3c to 5c that surround the desks 3 to 5 on three sides. The directional antennas 8A to 8C have a directivity capable of transmitting and receiving radio waves 10A to 10C in areas covered by the radio wave absorbers 3d to 5d.

The radio waves 10A to 10C emitted from the directional antennas 8A to 8C are also absorbed by radio wave absorbers 9A to 9C in a predetermined location above the desks 3 to 5, e.g., on the ceiling 2.

In the first embodiment, the radio waves 10A to 10C emitted from the directional antennas 8A to 8C of the wireless access points AP1 to AP3 are received by wireless antennas 7A to 7C of the terminals 6A to 6C located on the stage portions 3b to 5b of the desks 3 to 5, and desired communication is performed by the terminals 6A to 6C via, for example, the Internet. During the communication, the radio waves 10A to 10C emitted from the directional antennas 8A to 8C are absorbed by the radio wave absorbers 3d to 5d formed on the wall portions 3c to 5c of the desks 3 to 5, and are also absorbed by the radio wave absorbers 9A to 9C on the ceiling 2.

In the first embodiment, the wireless access points AP1 to AP3 are located in the desks 3 to 5 on which the terminals 6A to 6C are fixedly positioned. Thus, the distance between the terminals 6A to 6C and the wireless access points AP1 to AP3 can be set to a predetermined value regardless of the size of building in which the wireless communication system of the first embodiment is located. Thus, no operation is required for adjusting the distance between the terminals 6A to 6C and the wireless access points AP1 to AP3 each time the wireless communication system is installed in a particular place. The wireless communication system of the first embodiment is therefore easily installed at low cost.

The terminals 6A to 6C are placed on the stage portions 3b to 5b of the desks 3 to 5. Thus, the positional relationship between the terminals 6A to 6C and the wireless access points AP1 to AP3 is accurately fixed, and the directional antennas 8A to 8C of the wireless access points AP1 to AP3 are aligned with the terminals 6A to 6C in a one-to-one correspondence. This ensures that the directional antennas 8A to 8C are directed to the terminals 6A to 6C, respectively. Therefore, high-accuracy communication without interference is realized.

Since the directional antennas 8A to 8C are directed to the terminals 6A to 6C, communication is realized with a low output of the radio waves 10A to 10C emitted from the directional antennas 8A to 8C. This contributes to high-accuracy communication. The directional antennas 8A to 8C receive only the signals output from the corresponding terminals 6A to 6C, resulting in high signal-to-noise (S/N) ratio of the signals received by the directional antennas 8A to 8C. This also contributes to high-accuracy communication.

In the first embodiment, the directional antennas 8A to 8C are directed to the stage portions 3b to 5b, that is, to the ceiling 2, from the leg portions 3a to 5a of the desks 3 to 5. The radio waves 10A to 10C emitted from the directional antennas 8A to 8C do not reach terminals other than the corresponding terminals, and no interference can occur. This also contributes to high-accuracy communication.

In the first embodiment, the radio wave absorbers 3d to 5d are formed on the inner surfaces of the wall portions 3c to 5c that surround the desks 3 to 5 on three sides. The positional relationship between the desks 3 to 5 and the radio wave absorbers 3d to 5d is fixed. Therefore, the directional antennas 8A to 8C provided for the desks 3 to 5 and the radio wave absorbers 3d to 5d are accurately positioned. This prevents the occurrence of interference.

In the first embodiment, the radio waves 10A to 10C emitted from the directional antennas 8A to 8C are further absorbed by the radio wave absorbers 9A to 9C on the ceiling 2. This also prevents the occurrence of interference.

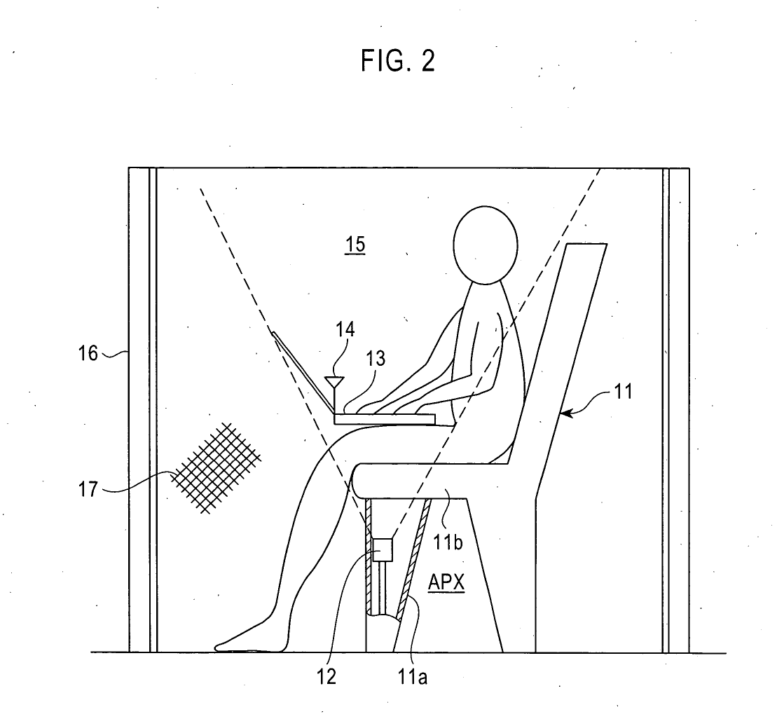

FIG. 2 is a diagram showing a wireless communication system according to a second embodiment of the present invention. Also in the second embodiment, the wireless communication system is disposed between a floor and a ceiling (not shown). A wireless access point APX is located in a chair 11 on which an operator of a terminal 13 sits. The wireless access point APX includes a wireless directional antenna 12. The directional antenna 12 is located in the chair 11, e.g., in a leg portion 11a of the chair 11, so that the directional antenna 12 is directed to a predetermined space above a seat 11b of the chair 11.

The chair 11 is surrounded on three sides by a wall portion 16, and a radio wave absorber 17 is formed on the inner surfaces of the wall portion 16. The directional antenna 12 has a directivity capable of transmitting and receiving radio waves in an area that is covered by the radio wave absorber 17. A radio wave absorber (not shown) is further formed in a predetermined location above the chair 11, e.g., on the ceiling.

In the second embodiment, when the operator sitting on the chair 11 operates the terminal 13 on, for example, his/her lap, radio waves 15 emitted from the directional antenna 12 of the wireless access point APX are received by a wireless antenna 14 of the terminal 13, and predetermined communication, e.g., Internet communication, is performed by the terminal 13. During the communication, the radio waves 15 emitted from the directional antenna 12 are absorbed by the radio wave absorber 17 formed on the internal surfaces of the wall portion 16, and are also absorbed by the radio wave absorber (not shown) on the ceiling.

In the second embodiment, the wireless access point APX is located in the chair 11 on which the operator who fixes the position of the terminal 13 sits. Thus, the distance between the terminal 13 and the wireless access point APX can be set to a predetermined value regardless of the size of building in which the wireless communication system of the second embodiment is located. Thus, no operation is required for adjusting the distance between the wireless access point APX and the terminal 13 each time the wireless communication system is installed in a particular place. The wireless communication system of the second embodiment is therefore easily installed at low cost.

The terminal 13 is placed on the lap of the operator sitting on the chair 11. Thus, the positional relationship between the terminal 13 and the directional antenna 12 of the wireless access point APX is substantially accurately fixed, and the directional antenna 12 of the wireless access point APX and the terminal 13 are aligned in a one-to-one correspondence. The radio waves 15 emitted from the directional antenna 12 cannot interfere with radio waves emitted from a directional antenna of an adjacent wireless access point (not shown). Therefore, high-accuracy communication is realized.

As in the first embodiment, communication is realized with a low output of the radio waves 15 emitted from the directional antenna 12. The directional antenna 12 receives only the signal output from the terminal 13, resulting in high S/N ratio.

In the second embodiment, the terminal 13 is placed on the lap of the operator sitting on the chair 11, and the position of the terminal 13 is substantially accurately determined. This ensures that the directional antenna 12 is directed to the terminal 13. Therefore, high-accuracy communication is realized.

In the second embodiment, the directional antenna 12 is directed to the seat 11b, that is, to the ceiling (not shown), from the leg portion 11a of the chair 11. The radio waves 15 emitted from the directional antenna 12 do not reach terminals other than the corresponding terminal 13, e.g., an adjacent terminal (not shown), and no interference can occur. This contributes to high-accuracy communication.

In the second embodiment, the radio wave absorber 17 is formed on the inner surfaces of the wall portion 16 that surrounds the chair 11 on three sides. The positional relationship between the chair 11 and the radio wave absorber 17 is fixed. Therefore, the directional antenna 12 provided for the chair 11 and the radio wave absorber 17 are accurately positioned. This prevents the occurrence of interference.

In the second embodiment, the radio waves 15 emitted from the directional antenna 12 are further absorbed by the radio wave absorber (not shown) on the ceiling above the chair 11. This also prevents the occurrence of interference.

1. A wireless communication system having a plurality of wireless access points,
wherein each wireless access point is provided for a terminal fixing unit for fixing the position of a wireless communication terminal, and
each wireless access point includes a directional antenna having a directivity that is directed to the position at which the terminal is fixed.

2. The wireless communication system according to claim 1, wherein the terminal fixing unit comprises a desk having a stage portion for carrying the terminal, and
the directional antenna is disposed in the desk so as to be directed to the stage portion of the desk.

3. The wireless communication system according to claim 2, wherein the directional antenna is disposed in a leg portion of the desk.

4. The wireless communication system according to claim 3, wherein a radio wave absorber is provided so as to surround the desk, and
the directional antenna has a directivity capable of transmitting and receiving radio waves in an area that is covered by the radio wave absorber.

5. The wireless communication system according to claim 3, wherein a second radio wave absorber is provided at a predetermined position above the desk.

6. The wireless communication system according to claim 1, wherein the terminal fixing unit comprises a chair on which an operator who operates the terminal sits, and
the directional antenna is disposed in the chair so as to be directed to a predetermined space above a seat of the chair.

7. The wireless communication system according to claim 6, wherein the directional antenna is disposed in a leg portion of the chair.

8. The wireless communication system according to claim 7, wherein a radio wave absorber is provided so as to surround the chair, and
the directional antenna has a directivity capable of transmitting and receiving radio waves in an area that is covered by the radio wave absorber.

9. The wireless communication system according to claim 7, wherein a second radio wave absorber is provided at a predetermined position above the chair.
